(19) United States
(12) Patent Application Publication
(10) Pub. No.: US 2011/0305840 A1
(43) Pub. Date: Dec. 15, 2011

(54) CHEMICAL CONVERSION TREATMENT LIQUID FOR METALLIC MATERIAL AND PROCESS FOR TREATMENT

(75) Inventor: Hitoshi ISHII, Tokyo (JP)

(73) Assignee: Henkel AG & Co. KGaA, Duesseldorf (DE)

(21) Appl. No.: 13/096,363

(22) Filed: Apr. 28, 2011

Related U.S. Application Data
(63) Continuation of application No. PCT/JP2009/005335, filed on Oct. 14, 2009.

(30) Foreign Application Priority Data
Oct. 31, 2008 (JP) 2008-281132

(51) Int. Cl. B05D 7/14; C09D 1/00; B05D 3/10

(52) U.S. Cl. 427/327; 106/286.6

(57) ABSTRACT

A zinc phosphate chemical conversion treatment liquid comprising 500 to 4,000 ppm of phosphate ions and 300 to 1,200 ppm of zinc ions, as a treatment liquid for depositing a zinc phosphate coating over the metallic material through chemical conversion treatment, wherein coefficient K (K=10^{X}×P²×Z³/10¹⁸) as calculated from phosphate ion concentration: P (ppm), zinc ion concentration: Z (ppm) and pH: X, is in the range of 1 to 50.

### CROSS-REFERENCE TO RELATED APPLICATION

This application is a national stage application under 35 USC 371 of PCT/JP2009/005335, filed Oct. 14, 2009, and published on May 6, 2010 as WO2010/050131, which claims priority from Japanese Patent Application No. 2008-281132, filed Oct. 31, 2008, which are incorporated herein by reference in their entireties.

### TECHNICAL FIELD

The present invention relates to chemical conversion treatment liquids for depositing thin-film zinc phosphate coatings which exhibit excellent performances as base for coating to metallic materials and processes for chemical conversion treatment using the same.

### BACKGROUND OF THE INVENTION

Traditionally, zinc phosphate-based chemical conversion treatment has been widely used as a process for chemical conversion treatment of base for coating, which imparts excellent corrosion resistance after coating and coating adhesion to various metallic materials.

Zinc phosphate chemical conversion treatment has been widely used for ages as a process for chemical conversion treatment of base for coating for steel materials. Also, this treatment is effective not only for steel materials but also for various metallic materials such as galvanized materials and aluminum alloy materials. In treatment, however, a considerable amount of sludge is generated and the sludge generated is in most cases land-filled as an industrial waste because the reuse thereof is difficult. In recent years, however, due to a steep rise in cost for disposal of the industrial waste, that is, sludge in this case, the whole cost for zinc phosphate chemical conversion treatment has increased, leading to a desire for improvement, in addition to environmental reasons.

There are countless techniques developed for zinc phosphate chemical conversion, examples of which may include Patent References described below.

Patent Reference 1 (Japanese Unexamined Patent Publication No. Sho-60-43491) describes a process for forming a phosphate chemical conversion coating over a steel surface, which comprises contacting a steel material with a phosphate chemical conversion treatment bath containing a phosphate to form a phosphate chemical conversion coating over the surface of the steel material, wherein the treatment bath has a temperature of 0° C. or higher and 40° C. or lower, a hydrogen ion concentration in the range of PH 2.2 to PH 3.5 and a redox potential in the range of 0 mV to 700 mV (hydrogen standard electrode potential). Also, in this Reference, while no description is made regarding the concentration of phosphate ions, a treatment bath having a phosphate ion concentration of 15,000 ppm is used in Examples. Further, it is mentioned as an effect obtained that dense, phosphate chemical conversion coatings can be obtained even with the use of the treatment bath at a lower temperature such as ordinary temperature.

Patent Reference 2 (Japanese Unexamined Patent Publication No. Sho-63-270478) describes a process for forming a phosphate chemical conversion coating over a surface of a steel material, which comprises contacting the steel material with a phosphate chemical conversion treatment liquid containing mixed anions including phosphate ions and various active anions other than phosphate ion, metal ions for forming chemical conversion coatings and an oxidizing agent to form the phosphate chemical conversion coating over the surface of the steel material, wherein the weight ratio of the phosphate ions (P) to the total mixed anions (An) in the chemical conversion treatment liquid is not higher than ½ and wherein the temperature of the chemical conversion treatment liquid is maintained at 40° C. or lower without external heating. In Claim 5 of this Reference, description is made regarding the pH of the treatment liquid of 0.5 to 4.5 and in Claim 13, description is made of phosphate ions in the treatment liquid of 4.5 to 9.0 g/l. Further, it is mentioned as an effect obtained that coatings can be formed at ordinary temperature of 40° C. or lower.

Patent Reference 3 (Japanese Unexamined Patent Publication No. Hei-5-287549) describes a process for zinc phosphate treatment of a metal surface for cationic electrodeposition coating, which comprises contacting the metal surface having an iron-based surface, an zinc-based surface and an aluminum-based surface simultaneously with an acidic zinc phosphate treatment liquid to form a zinc phosphate coating over the metal surface, wherein the acidic zinc phosphate treatment liquid does not contain nickel ions and contains 0.1 to 4 g/l of cobalt ions, 0.1 to 3 g/l of manganese ions, a coating chemical conversion accelerator (a), 200 to 500 mg/l of a simple fluoride in terms of HF concentration and a complex fluoride at a molar ratio to the simple fluoride of 0.01 to 0.5. Also, in this Reference, a preferred concentration of phosphate ions is stated as from 5 to 40 g/l and, although no description is made regarding the pH of the treatment liquid, free acidity is adjusted to 0.7 throughout Examples. Further, it is mentioned as an effect obtained that zinc phosphate coatings excellent in coating adhesion and corrosion resistance can be formed with even no nickel contained in the treatment liquid.

Patent Reference 4 (Japanese Unexamined Patent Publication No. Hei-5-331658) describes a process for zinc phosphate treatment of a metal surface, which comprises contacting the metal surface with an acidic zinc phosphate treatment liquid containing 0.1 to 2 g/l of zinc ions, 5 to 40 g/l of phosphate ions, 0.001 to 3 g/l of a lanthanum compound as a lanthanum metal and a coating conversion accelerator (a) as principal components to form a zinc phosphate coating over the metal surface. Also, in this Reference, although no description is made regarding the pH of the treatment liquid, free acidity is adjusted to 0.7 throughout Examples. Further, it is mentioned as an effect obtained that excellent coating adhesion and corrosion resistance may be obtained.

Patent Reference 5 (Japanese Unexamined Patent Publication No. Hei-8-134661) describes a process for zinc phosphate treatment of a metal surface for cationic electrodeposition coating, which comprises contacting the metal surface with an acidic zinc phosphate coating treatment liquid to form a zinc phosphate coating over the metal surface, wherein the acidic zinc phosphate coating treatment liquid contains 0.1 to 4 g/l of cobalt ions, 0.1 to 3 g/l of manganese ions, a coating chemical conversion accelerator (a), 200 to 500 mg/l of a simple fluoride in terms of HF concentration and a complex fluoride at a molar ratio to the simple fluoride of 0.01 to 0.5. Also, in this Reference, a preferred concentration of phosphate ions is stated as from 5 to 40 g/l and, although no description is made regarding the pH of the treatment liquid, free acidity is adjusted to 0.7 throughout Examples. Further, it is mentioned as an effect obtained that zinc phosphate coatings excellent in coating adhesion and corrosion resistance can be formed even with no nickel contained in the treatment liquid.

Patent Reference 6 (Japanese Unexamined Patent Publication No. Hei-8-158061) describes a zinc phosphate-based chemical conversion treatment liquid for metallic materials, which contains zinc ions and phosphate ions as principal components, has a the pH of 2 to 4 and further contains 5 to 50 ppm of ferric ions, ferrous ions 5 times or less in content of ferric ions and 50 to 500 ppm of fluoride ions. Also, in this Reference, although no description is made regarding the concentration of phosphate ions, the range is 13 to 17 g/l according to Examples and the pH range of the treatment liquid is 2.5 to 3.3 also according to Examples. Further, it is mentioned as effects obtained that uniform and dense, zinc phosphate-based chemical conversion coatings may be obtained and that a reduction in consumption and simplification of maintenance of chemical conversion treatment liquids are enabled.

Patent Reference 7 (Japanese Unexamined Patent Publication No. Hei-8-246161) describes a process for phosphate treatment of a surface of a member, which is made of aluminum alloys, with a zinc phosphate chemical conversion treatment liquid, wherein the treatment is made under the conditions that, regarding the zinc phosphate chemical conversion treatment liquid, fluorine ion concentration is 100 to 200 ppm, silicofluoric acid concentration is 750 to 1,000 ppm and free acidity is 0.5 to 0.8. Also, in Examples of this Reference, phosphate ion concentration is indicated as in the range of 5 to 30 g/l. Further, it is mentioned as an effect obtained that high-quality, zinc phosphate coating excellent in corrosion resistance can be produced on composite members made of aluminum alloy members and steel members.

Patent Reference 8 (Japanese Unexamined Patent Publication No. Hei-8-302477) describes a zinc phosphate-based chemical conversion treatment liquid for metallic materials, which comprises a chemical conversion accelerator consisting of 50 to 1,500 ppm of at least one type of organic peroxide in an aqueous solution containing zinc and phosphate ions as principal components. Also, in Claim 9 of this Reference, the treatment liquid pH is described as 2.0 to 4.0 and, in the text, a preferred phosphate ion concentration is described as 5.0 to 30.0 g/l. Further, it is mentioned as an effect obtained that dense, zinc phosphate-based chemical conversion coatings containing extremely fine chemical conversion crystals can be formed uniformly over the metallic materials, thereby enabling to improve coating adhesion.

Patent Reference 9 (Japanese Unexamined Patent Publication No. 2001-323384) describes a process for chemical conversion treatment through dipping with the use of an acidic aqueous zinc phosphate solution, wherein an aqueous zinc nitrite solution containing 5% to 40% by weight of zinc nitrite as an accelerator and containing 0 to 100 ppm of sodium ions and 0 to 50 ppm of sulfate ions on weight basis is used. Also, in Claim 2 of this Reference, a phosphate ion concentration is described as 5.0 to 30.0 g/l and, although no description is made regarding the pH of the treatment liquid, in the text, preferred free acidity is described as 0.5 to 2.0. Further, it is mentioned as effects obtained that zinc phosphate coatings suitable for cationic electrodeposition are formed and that it is also suitable for closed systems.

Patent Reference 10 (Japanese Unexamined Patent Publication No. 2003-64481) describes an zinc phosphate treatment agent having an aluminum-based surface, which contains 0.1 to 2 g/l of zinc ions, 0.1 to 4 g/l of nickel ions, 0.1 to 3 g/l of manganese ions, 5 to 40 g/l of phosphate ions, 0.1 to 15 g/l of nitrate ions, 0.2 to 0.4 g/l of nitrites and, as fluorides, 0.1 to 2 g/l of a complex fluoride in terms of F and 0.3 to 0.5 g/l of a simple fluoride in terms of F. Also in this Reference, the pH of the treatment agent is described as approximately 2 to 5. Further, it is mentioned as an effect obtained that uniform and dense, zinc phosphate coatings excellent in corrosion resistance such as filiform corrosion resistance can be formed over aluminum-based surfaces without causing nonuniformity in chemical conversion.

Patent Reference 11 (Japanese Examined Patent Publication No. Hei-3-31790) describes an aqueous solution for zinc phosphate chemical conversion treatment to be contacted with metal surfaces for chemical conversion thereof, which contains (A) to (D) below:

(A) 0.05% to 2.5% of zinc ions;

(B) 0.15% to 7.5% of phosphate ions;

(C) 0.05% to 5% of aromatic nitroanions; and

(D) 0.05% to 5% of chlorate anions,

wherein the weight ratio between the water-soluble chlorate anions and the aromatic nitroanions is 2:1 or lower to 1:10. Also, in Claim 9, it is stated that the treatment liquid has a pH of 2 to 3.5. Further, it is mentioned as an effect obtained that improvement in economy and zinc phosphate chemical conversion coatings may be obtained.

Patent Reference 12 (Japanese Examined Patent Publication No. Hei-6-96773) describes a process for forming a zinc phosphate coating over a metal surface, which comprises treating the metal surface with an aqueous zinc phosphate solution to form the zinc phosphate coating, wherein the aqueous zinc phosphate solution contains more than 2 g/l but not more than 20 g/l of zinc ions, more than 5 g/l but not more than 40 g/l of phosphate ions and 0.005 g/l or more but not more than 20 g/l, in terms of tungsten, of tungstosilicic acid and/or a tungstosilicate salt. Also, in this Reference, although no description is made regarding the pH of the treatment liquid, free acidity is adjusted at from 0.2 to 1.5 according to Examples. Further, it is mentioned as an effect obtained that zinc phosphate coatings having sufficient film weight may be formed while inhibiting the deterioration of film quality.

Patent Reference 13 (Japanese Examined Patent Publication No. Hei-7-30455) describes a phosphate chemical conversion liquid comprising a zinc phosphate-based chemical conversion liquid containing nickel ions, to which formic acid or a salt thereof is added. Also, in Claim 3 of this Reference, the concentration of phosphate ions is stated as 10 to 25 g/l and, although no description is made regarding the pH of the treatment liquid, free acidity is adjusted at 0.1 to 1.1 according to Examples. Further, it is mentioned as an effect obtained that it is particularly effective at a temperature of about 45° C. or lower according to a dipping method.

Patent Reference 14 (Japanese Examined Patent Publication No. Hei-8-19531) describes a process for acidic zinc phosphate treatment containing 0.01 to 10 g/l of colloidal particles having a dispersed particle diameter of 0.001 to 0.1 μ, for metal surfaces at an isoelectric point not higher than 3. Also, in Claim 2 of this Reference, the concentration of phosphate ions is stated as 5 to 40 g/l and, although no description is made regarding the pH of the treatment liquid, free acidity is adjusted at 0.2 to 0.9 according to Examples. Further, it is mentioned as an effect obtained that zinc phosphate coatings excellent in coating adhesion, corrosion resistance, in particular warm salt water resistance and scab corrosion resistance may be obtained.

Patent Reference 15 (Japanese Examined Patent Publication No. Hei-8-19532) describes a process for zinc phosphate treatment of a metal surface, which comprises treating the metal surface with an acidic aqueous zinc phosphate treatment solution containing 0.01 to 20 g/l of a soluble tungsten compound as tungsten. Also, in Claim 2 of this Reference, the concentration of phosphate ions is stated as 5 to 40 g/l and, although no description is made regarding the pH of the treatment liquid, free acidity is adjusted at 0.2 to 0.9 according to Examples. Further, it is mentioned as an effect obtained that zinc phosphate coatings excellent in coating adhesion, corrosion resistance, in particular warm salt water resistance and scab corrosion resistance may be obtained.

Patent Reference 16 (Patent Publication No. 2783466) describes a process for chemical conversion treatment of metallic materials with the use of a zinc phosphate-based chemical conversion treatment liquid, wherein the pH of the fluorine-containing, zinc phosphate-based chemical conversion treatment liquid is controlled according to the variation in concentration of dissociated fluorine ions (F). Also, in Claim 5, the concentration of phosphate ions is stated as 10 to 25 g/l and, although no specific description is made regarding the pH, the pH range of the treatment liquid is 3.0 to 4.2 according to Examples. Further, it is mentioned as an effect obtained that zinc phosphate-based, chemical conversion coatings excellent in corrosion resistance after coating and coating adhesion may be formed.

Patent Reference 17 (Patent Publication No. 3088623) describes a process for forming zinc phosphate coatings over a metal surface, which comprises contacting the metal surface with an acidic zinc phosphate coating treatment liquid to form a zinc phosphate coating over the metal surface, wherein the acidic zinc phosphate coating treatment liquid contains 0.1 to 2 g/l of zinc ions, 0.1 to 4 g/l of nickel and/or cobalt ions, 0.1 to 3 g/l of manganese ions, 0.005 to 0.2 g/l of copper ions, 0.01 to 0.5 g/l of ferric ions, 5 to 40 g/l of phosphate ions, 0.1 to 15 g/l of nitrate ions and 0.05 to 3 g/l of a fluorine compound (in terms of F) as principal components and a coating chemical conversion accelerator. Also, in this Reference, although no description is made regarding the pH of the treatment liquid, free acidity is adjusted to 0.8 throughout Examples. Further, it is mentioned as effects obtained that high rust prevention effect may be exhibited at a small amount of coating and that the amount of zinc phosphate sludge byproduced during the treatment may be reduced.

### SUMMARY OF INVENTION

In one aspect, the invention provides a chemical conversion treatment liquid for a metallic material, which is an aqueous solution at pH 3.6 to 4.4 containing 500 to 4,000 ppm of phosphate ions, 300 to 1,200 ppm of zinc ions and, preferably, a coating chemical conversion accelerator, as a treatment liquid for depositing a zinc phosphate coating over the metallic material through chemical conversion treatment, wherein coefficient K as calculated from phosphate ion concentration: P (ppm), zinc ion concentration: Z (ppm) and pH: X is in a range of 1 to 50.

K=10^{X}×P²×Z³/10¹⁸ (Formula I)

The chemical conversion treatment liquid for a metallic material may further comprise nitrate ions, fluoride ions and, as a coating chemical conversion accelerator, nitrite ions or hydroxylamine, wherein concentration of the fluoride ions is 20 to 240 ppm.

Another aspect of the invention is a process for chemical conversion treatment of a metallic material, which comprises contacting surfaces of the metallic material with a surface conditioning liquid at pH 7.0 to 11.0 containing 100 to 2,000 ppm of fine zinc phosphate particles and, immediately thereafter, contacting with the chemical conversion treatment liquid according to the invention held at 30 to 60° C. to form a zinc phosphate coating over the surface of the metallic material.

### BRIEF DESCRIPTION OF THE DRAWINGS

FIG. 1 is a graph showing phosphate ion and zinc ion concentrations along X and Y axes, with comprehensive evaluation results plotted at respective locations (pH 3.6).

FIG. 2 is a graph showing phosphate ion and zinc ion concentrations along X and Y axes, with comprehensive evaluation results plotted at respective locations (pH 4.0).

FIG. 3 is a graph showing phosphate ion and zinc ion concentrations along X and Y axes, with comprehensive evaluation results plotted at respective locations (pH 4.4).

### DETAILED DESCRIPTION OF THE INVENTION

The prior art references described above are intended to overcome various disadvantages of conventional zinc phosphate chemical conversion treatments and, among them, however, it is only in Patent Reference 17 that a reduction in the amount of consumed sludge is described as an effect to be obtained.

Patent Reference 17 describes the amount of iron eluted from cold-rolled steel sheets as an indicator of the amount of generated sludge in Examples. Specific amounts of eluted iron are 0.5 to 0.7 g/m² according to Examples 1 to 4 and 0.1 g/m² according to Example 5. Since an amount of eluted iron and an amount of produced sludge are not completely proportional, the amount of generated sludge may not be accurately calculated only on the basis of the amount of eluted iron. For estimated amounts of sludge, however, those in Examples 1 to 4 are insufficient and that in Example 5 is sufficient. The results, however, relied on the use of treated materials made of cold-rolled steel sheets and aluminum in combination, hardly to be considered an effect attributable to the compositions of the treatment liquids.

When iron and aluminum remaining in contact are dipped in an acidic aqueous solution, electromotive force will be generated between the metals due to the difference in standard electrode potential between the metals, which inhibits elution of iron. The reduction in the amount of eluted iron in Example 5 of Patent Reference 17 owes much to such an action. In other words, it is easy to predict that when treatment is carried out using cold-rolled steel sheets only, the amount of eluted iron will be equivalent to those in Examples 1 to 4. When cold-rolled steel sheets and aluminum alloy sheets are contacted, while the amount of eluted iron will be reduced due to the above electro-chemical action, the amount of aluminum eluted off of the aluminum alloy sheets will rather increase, which will be rendered sludge in time. Therefore, this process for treatment has no effects of reducing the amount of generated sludge.

Further, although Patent References 1 to 16 were reviewed, no effects of reducing the amount of generated sludge have been discovered.

The present inventors have studied means for solving the problems described above, that is, methods for reducing the amount of generated sludge and have reached a conclusion that it is most important to maintain the pH of a treatment liquid high.

As such, after investigating the pH of the treatment liquids of the prior art, it was found that the pH was below 3.6 with the exception of Patent References 2, 6, 10 and 16. For References with no description regarding the pH, free acidity is usually described instead. Free acidity is one of control items for treatment liquids for zinc phosphate chemical conversion treatment, in which when 10 ml of a treatment liquid are sampled and neutralization titration is carried out using 0.1 mol/l of NaOH as a titrant, the mL of the titrant will be indicated as a point. An endpoint is considered a point of discoloration with the use of Bromophenol Blue as an indicator or a point where pH 3.6 is reached according to the indication by a pH meter. Since the point of discoloration of Bromophenol Blue is at pH 3.6, however, determination results will not differ, whichever method is used. In other words, when a positive value is indicated as free acidity, at least the pH of the treatment liquid will be interpreted as below 3.6. This control item and this method for determination are extremely conventional for those skilled in the art.

Next, the present inventors reviewed the details of the four Patent References described above which contain description of pH 3.6 or higher. Patent Reference 2 describes the pH of the treatment liquid of 0.5 to 4.5 in Claim 5 and phosphate ions in the treatment liquid of 4.5 to 9.0 g/l in Claim 13. Further, it is mentioned as an effect obtained that coatings can be formed at normal temperature of 40° C. or lower. Examining implemented Examples, however, the pH of the treatment liquid is higher than 3.6 only in Example 4, with a phosphate ion concentration of 3 g/l at pH 3.9, which falls below the preferred range. Further, since the treatment liquid can be stable because of a low temperature of 20 to 25° C., coatings deposited from a treatment liquid at such a low temperature may not satisfy high coating performances. When the treatment temperature is raised, stability of the treatment liquid will in turn be impaired, leading to a large amount of generated zinc phosphate sludge.

Although the pH of the treatment liquid in Patent Reference 6 is stated as 2 to 4, examining Examples, the pH is in the range of 2.5 to 3.3 (0.8 to 5.0 in free acidity) with no cases of pH 3.6 or higher. Also for Patent Reference 10, although the pH of the treatment liquid is described as approximately 2 to 5, the treatment liquids used in Examples are adjusted at free acidity of 0.5, with no cases of pH 3.6 or higher.

In Patent Reference 16, since the pH to be maintained continues to fluctuate according to the concentration of dissociated fluorine ions, the pH of the treatment liquid will exceed 3.6 in regions where the concentration of dissociated fluorine ions is high, in particular, higher than 300 ppm. This is attributable to the fact that the treatment liquid is stabilized due to the complex forming action of the dissociated fluorine ions with zinc ions. In this case, however, due to the excessive concentration of the dissociated fluorine ions, etching will be excessive for iron-based materials and the amount of deposited coating will be insufficient, in conjunction with an undesired increase in the amount of generated sludge.

In other words, cases where the pH of a treatment liquid exceeds 3.6 are extremely rare and it has been difficult to maintain the stability of the treatment liquid, except by lowering the temperature to 25° C. or lower or by adding excessive dissociated fluorine. Also, even with the use of such a stabilized treatment liquid, it has been substantially impossible to form coatings capable of satisfying coating performances and to reduce the amount of generated sludge.

As a result of repeatedly conducting further reviews for a procedure capable of holding the pH of a treatment liquid at 3.6 or higher, the present inventors have discovered that it can be attained by lowering the concentration of phosphate ions as an essential component of a zinc phosphate chemical conversion treatment liquid. A suitable concentration thereof is 500 to 4,000 ppm, that is, approximately one tenth of common-sense phosphate ion concentrations, approximately 5,000 to 30,000 ppm, found in large numbers in the prior art (Patent References 1 to 17).

Since the phosphate ion concentrations in the prior art are not excessive at all, however, some disadvantage will arise through lowering concentrations. It is that chemical conversion treatability is easily impaired by the variation in concentration of zinc ions in trace amounts. Then, the present inventors have finally succeeded in specifying appropriate zinc ion concentrations in accordance with pH and phosphate ion concentrations and defining the range by a mathematical formula.

This mathematical formula derives coefficient K in proportion to the square of a phosphate concentration times, the cube of a zinc ion concentration times and a value using a pH value as the power of 10. In general, when a deposition reaction of zinc phosphate ions is represented by a chemical formula, it will be as Formula 2, which corresponds to the equilibrium constant of this mathematical formula. Therefore, this may be considered a logical defining method.

3Zn²⁺+2H₂PO₄⁻+5H₂O=Zn₃(PO₄)₂4H₂O+4H⁺ (Formula 2)

It has also been discovered that it is advantageous to use a surface conditioning agent including fine zinc phosphate particles as a principal component, in order to further secure sufficient chemical conversion treatability. Thereby, we have finally succeeded in forming coatings capable of satisfying coating performances and in dramatically reducing the amount of generated sludge.

Specifically, the present inventions are (1) to (3) below.

(1) A chemical conversion treatment liquid for a metallic material, which is an aqueous solution at pH 3.6 to 4.4 containing 500 to 4,000 ppm of phosphate ions, 300 to 1,200 ppm of zinc ions and, preferably, a coating chemical conversion accelerator, as a treatment liquid for depositing a zinc phosphate coating over the metallic material through chemical conversion treatment, wherein coefficient K as calculated from phosphate ion concentration: P (ppm), zinc ion concentration: Z (ppm) and pH: X is in the range of 1 to 50:

K=10^{X}×P²×Z³/10¹⁸ (Formula 1).

(2) The chemical conversion treatment liquid for a metallic material according to the invention (1) which contains nitrate ions, fluoride ions and, as a coating chemical conversion accelerator, nitrite ions or hydroxylamine, wherein the concentration of the fluoride ions is 20 to 240 ppm.

(3) A process for chemical conversion treatment of a metallic material, which comprises contacting the metallic material with a surface conditioning liquid at pH 7.0 to 11.0 containing 100 to 2,000 ppm of fine zinc phosphate particles and, immediately thereafter, with the chemical conversion treatment liquid of the invention (1) or (2) held at 30 to 60° C. to form a zinc phosphate coating over the surface of the metallic material.

Now, definition of each term used in CLAIMS and DESCRIPTION will be described. A “zinc phosphate coating” is not particularly limited as long as it is a coating which contains zinc phosphate and may contains other components as well, examples of which may include those whose principal components are Hopeite and/or Phosphophyllite. “ppm” means “mg/l”.

Zinc ions can be determined by atomic absorption spectrometry or ICP. Also, phosphate ion in the present invention does not refer only to PO₄³⁻, but is a generic term encompassing phosphate ion (PO₄³⁻), hydrogen phosphate ion (HPO₄²⁻), dihydrogen phosphate ion (H₂PO₄⁻) and free phosphoric acid (H₃PO₄) whose concentration can be determined by ion chromatography. While the four forms of phosphate ions described above can be reversibly altered depending on pH, a phosphate ion will generally assume the form of dihydrogen phosphate (H₂PO₄⁻) at the pH range specified in the present invention (3.6 to 4.4), the other forms existing only negligibly. Further, fluoride ions are those detected at fluorine ion electrodes and assume the form of F⁻, exclusive of the features of complex fluoride ions such as AlF₃ and SiF₆²⁻ as well as HF.

Metallic materials to be treated by the treatment liquids according to the present invention are not particularly limited, examples of which may include steel materials such as cold-rolled steel sheets, hot-rolled steel sheets, castings and steel pipes, such steel materials having zinc-based plating and/or aluminum-based plating thereon, aluminum alloy sheets, aluminum-based castings, magnesium alloy sheets and magnesium-based castings. Suitable zinc phosphate coatings can be provided over the surfaces of such metallic materials.

Among metallic materials, for austenite-based stainless steels, nickel alloys and titanium alloys as well as other noble metals having standard electrode potentials of 0 V or higher, etching reaction in the treatment liquid will be insufficient so that sufficient coating deposition may be difficult. However, properties of the treatment liquids may not be impaired by treating such materials. It also applies to precoated metallic materials and resin materials.

The treatment liquid according to the present invention is one for depositing zinc phosphate coatings through chemical conversion over cleaned surfaces of metallic materials and contains phosphate and zinc ions as essential components and, preferably, a coating chemical conversion accelerator.

The phosphate ions are a coating component and have a concentration in the treatment liquid of 500 to 4,000 ppm, more preferably 750 to 3,500 ppm and most preferably 1,000 to 3,000 ppm. Below 500 ppm, deposition of chemical conversion coatings will be insufficient in amount, while over 4,000 ppm, it will be difficult to maintain pH at 3.6 or higher and, thus, impossible to inhibit the amount of generated sludge. Also, using an alkali to forcibly increase the pH will generate a large amount of sludge due to neutralization.

While supply of phosphate ions is not limited in the form, phosphate ions are generally supplied in the form of an aqueous solution of phosphoric acid or in the form of phosphate salts such as sodium hydrogen phosphate, ammonium hydrogen phosphate, zinc phosphate and nickel phosphate, for example.

The zinc ions are also a coating component and have a concentration in the treatment liquid of 300 to 1,200 ppm, more preferably 400 to 1,100 ppm and most preferably 500 to 1,000 ppm. Below 300 ppm, deposition of chemical conversion coatings will be insufficient in amount, while over 1,200 ppm, stability of the treatment liquid will be impaired, leading to a large amount of generated zinc phosphate sludge. Also, the quality of coatings obtained will degrade. While supply of zinc ions is not limited in the form, zinc ions are generally supplied in the form of metal zinc, zinc oxide, zinc hydroxide or in the form of zinc salts such as zinc phosphate, zinc nitrate and zinc fluoride, for example.

The concentration range of zinc ions described above relates to an absolute value and, even within this range, there are concentration regions where failures may occur in relationship with phosphate ion concentrations and/or pH. In other words, a limiting condition to be described below must further be satisfied.

The limiting condition is the range of coefficient K as calculated from phosphate ion concentration: P (ppm) and zinc ion concentration: Z (ppm) in the treatment liquid and pH: X. This coefficient is calculated according to Formula 1 and its range is 1 to 50, more preferably 2 to 40 and most preferably 3 to 30.

K=10^{X}×P²×Z³/10¹⁸ (Formula 1).

Even when each of the phosphate ion concentration and the zinc ion concentration is in the predetermined concentration range, if the coefficient K falls below 1, deposition of chemical conversion coatings will be insufficient in amount, while over 50, stability of the treatment liquid will be impaired, leading to a large amount of generated zinc phosphate sludge, similar to the case of excessive zinc ion concentration. Also, the quality of coatings obtained will degrade. In other words, the concentrations of phosphate and zinc ions need to simultaneously satisfy the limitation by the respective concentration ranges and the limitation by the coefficient K.

A liquid medium for composing the present liquid may be water or an aqueous medium containing 80% by weight or more of water. Although organic solvents may be used as medium other than water, contents of such organic solvents should preferably be kept low, preferably at 10% by weight or less and, more preferably, at 5% by weight or less, based on the aqueous medium.

Here, preferred treatment liquids are those containing 500 to 4,000 ppm of phosphate ions and 300 to 1,200 ppm of zinc ions and having the coefficient K in the range of 1 to 50. More preferred treatment liquids are those containing 750 to 3,500 ppm of phosphate ions and 400 to 1,100 ppm of zinc ions and having the coefficient K in the range of 2 to 40. Most preferred treatment liquids are those containing 1,000 to 3,000 ppm of phosphate ions and 500 to 1,000 ppm of zinc ions and having the coefficient K in the range of 3 to 30.

The treatment liquids according to the present invention further contain a coating chemical conversion accelerator. As coating chemical conversion accelerators, one type or two or more types among nitrite ion, hydroxylamine, chlorate ion, bromate ion, nitrobenzensulfonate ion, organic peroxide, hydrogen peroxide and the like may be selected, nitrite ion or hydroxylamine being preferred. Nitrite ions are supplied as metal salts such as sodium salt and zinc salt or as an aqueous solution thereof. Hydroxylamine is supplied as an aqueous hydroxylamine solution, as a salt such as sulfate or phosphate salt or as an aqueous solution thereof.

The temperature of the treatment liquid according to the present invention is 30 to 60° C., more preferably 33 to 50° C. and most preferably 35 to 45° C. Below 30° C., coating quality satisfying desired coating performances may not be obtained, while over 60° C., it will not only be economically disadvantageous but also lead unfavorably to the generation of zinc phosphate sludge. These temperatures are specified from the viewpoint of reactivity in treatment and are not influenced in any way during the storage of treatment liquids.

The pH of the treatment liquid according to the present invention is 3.6 to 4.4, more preferably 3.7 to 4.3 and most preferably 3.8 to 4.2. When the pH of the treatment liquid falls below 3.6, deposition of chemical conversion coatings will be insufficient in amount, while over 4.4, stability of the treatment liquid will be impaired, leading to a large amount of generated zinc phosphate sludge.

Chemicals to be used when it is necessary to adjust the pH of a treatment liquid are not particularly limited, examples of which may include acids, such as phosphoric acid, sulfuric acid, nitric acid, hydrofluoric acid and organic acids and alkalis such as lithium hydroxide, potassium hydroxide, sodium hydroxide, sodium carbonate, aqueous ammonia, ammonium carbonate, ammonium hydrogen carbonate and triethanolamine. The pH of the treatment liquids according to the present invention can be easily determined by a pH meter using commercially available pH electrodes.

Further, the treatment liquids according to the present invention should preferably contain nitrate and fluoride ions. Nitrate ions can be added not only as nitric acid but also as nitrate salts such as zinc nitrate, sodium nitrate and ammonium nitrate.

Nitrate ions act as an oxidizing agent in the treatment liquids. When metallic materials are etched in the treatment liquids, in the absence of nitrate ions, hydrogen ions will be reduced to generate hydrogen gas so that coating crystals may grow coarser due to the physical action of the gas generation, while, in the presence of nitrate ions, the nitrate ions will be reduced instead of hydrogen ions to efficiently increase the pH on the metal surface without gas generation so that coating depositing reaction may be accelerated and coating crystals may be finely divided.

Nitrate ions can exhibit the action described above at a wide range of concentration and, therefore, the concentration is not particularly limited. Typically, it is, however, approximately 1,000 to 10,000 ppm.

Fluoride ions can be added in the form of simple fluorides such as hydrofluoric acid, sodium fluoride, sodium hydrogen fluoride and ammonium hydrogen fluoride or in the form of complex fluorides such as silicofluoric acid, sodium silicofluoride and ammonium silicofluoride. Although a complex fluoride forms a fluorine complex in the treatment liquids, part of it will surely be liberated through dissociation into a simple fluoride, with no problem as a source.

The concentration of fluoride ions should preferably be 20 to 240 ppm. Fluoride ions have an action of efficiently removing oxide films on metallic material surfaces. When the concentration falls below 20 ppm, the effect may not be sufficiently exhibited, with a delay in coating deposition, while over 240 ppm, an increase in etching power will increase the amount of generated sludge.

Metallic materials to be treated according to the present invention should preferably be cleaned in advance by degreasing treatment. Methods for degreasing are not particularly limited and conventionally known methods may be used. Cleaned metal materials should preferably be surface-conditioned prior to chemical conversion treatment and, as a surface conditioning treatment liquid, an aqueous liquid at pH 7.0 to 11.0 containing 100 to 2,000 ppm of fine zinc phosphate particles (e.g., having a particle diameter of 5 μm or smaller) should preferably be used. As such surface conditioning treatment liquids, those described in Japanese Patent No. 3451334 and Japanese Patent No. 3451337 may be mentioned.

As surface conditioning treatment liquids for zinc phosphate chemical conversion treatment, those based on titanium colloid and zinc phosphate are known. For the chemical conversion treatment liquids according to the present invention, zinc phosphate-based surface conditioning may be combined to make it more effective.

When the concentration of fine zinc phosphate particles falls below 100 ppm, surface conditioning effects by the fine zinc phosphate particles will be insufficient, with no sufficient chemical conversion treatability obtained, while over 2,000 ppm, effects will reach saturation, not only causing economical disadvantages but also unfavorably increasing, although slightly, sludge in the zinc phosphate chemical conversion treatment. Also, below pH 7.0, stability of the fine zinc phosphate particles as a principal component of the surface conditioning agent will be impaired so that the effect of finely dividing coating crystals due to the surface conditioning agent may prematurely degrade, while over pH 11, introduction of an alkali into the zinc phosphate chemical conversion treatment will increase the amount of generated zinc phosphate sludge.

It is possible to carry out degreasing and surface-conditioning simultaneously by adding an optional surface active agent to the surface conditioning treatment liquid. Nonionic, anionic, cationic and amphoteric surface active agents can be used, nonionic surface active agents being most preferred. Suitable surface active agents can be selected according to the type and amount of oil adhered to the material and used at a general concentration of approximately 100 to 2,000 ppm.

Further, the treatment liquids according to the present invention may directly contain surface active agents and degreasing and surface-conditioning treatments may be omitted. The type and concentration of surface active agents do not matter, similar to the foregoing. In such cases, since surface conditioning agents that are unstable in acidic regions may not be added simultaneously, a slight decrease in coating quality may occur. However, a considerable shortening of the process may be enabled and huge advantages may be provided depending on the required coating quality.

For primarily improving coating performances, polyvalent metal ions other than zinc ions may be added to the treatment liquids according to the present invention. One type or two or more types selected from nickel ion, manganese ion, magnesium ion, cobalt ion, copper ion and the like may be selected to be added in the form of a nitrate salt, sulfate salt, phosphate salt, oxide, hydroxide and the like, respectively. The added concentration of the metals described above is not particularly limited, but is in the range of approximately 20 to 1,000 ppm as the total concentration.

Since the treatment liquids according to the present invention are those for depositing zinc phosphate coatings over metallic materials through chemical conversion and are based on the presupposition that chemical conversion treatment is used, the treatment may be carried out by spraying and/or dipping. Although chemical conversion is basically electroless, partially electrolytic treatment, in particular cathodic electrolysis using a metallic material as the cathode may also be used, without impairing the effects of the present invention.

The period of time for chemical conversion treatment is not particularly limited, but should preferably be 30 to 300 seconds. An amount of coating in the preferred range tends to be obtained in this range of treatment time.

After chemical conversion treatment, it is preferred to carry out water rinsing. Methods for water rinsing are not particularly limited and methods such as dipping and spraying may be applied. The treatment liquids according to the present invention contain various salts and, when coating is carried out with such salts remaining, it may cause failure in coating adhesion. A water rinsing step may be carried out stepwise so that efficiency in water rinsing may be improved. Since the quality of water for water rinsing may vary depending on the type of coating to be subsequently carried out, the quality of water for water rinsing is not particularly limited. However, the concentration is preferably 1% and, more preferably, 0.1% or lower based on the chemical conversion liquid.

Steel materials that have been subjected to chemical conversion treatment with the chemical conversion liquids according to the present invention and have further been subjected to water rinsing will subsequently be subjected to coating.

Coating is not particularly limited in type and conventionally known solvent coating, water-based coating, electrodeposition coating, powder coating and the like are used. It is desirable to drain and dry before coating for solvent coating and powder coating where moisture on the material surface may cause harmful effects at the time of coating. Otherwise, a drying step, in particular, is not essential.

The worst weakness of zinc phosphate chemical conversion treatment is the sludge generated through the treatment and the present invention has enabled to greatly reduce the amount of generated sludge in comparison with conventional zinc phosphate chemical conversion treatments. Also, the reduction in the amount of generated sludge has led to a reduction in the consumption of phosphoric acid contained in the sludge and has enabled a reduction of phosphate ions carried over to the subsequent step of water rinsing by virtue of a reduction in the concentration of phosphate ions in the treatment liquid.

In other words, the present invention is intended to provide treatment liquids and processes for treatment which may have similar coating performances to conventional zinc phosphate chemical conversion treatments of various metallic materials and enable to greatly reduce the amount of generated sludge and the consumption of chemicals.

### EXAMPLES

Embodiments of the present invention will be specifically illustrated below, with reference to Examples and Comparative Examples.

First, as Experiment 1, for the purpose of defining appropriate ranges of phosphate ion and zinc ion concentrations in zinc phosphate chemical conversion treatment liquids, stabilities of the treatment liquids with various concentrations of the both ions were investigated and, for the stability levels obtained, actual metallic materials were treated to investigate the qualities of coatings and the amounts of generated sludge.

For a zinc phosphate chemical conversion liquid, using 75% phosphoric acid and zinc nitrate, phosphate ions and zinc ions were added at predetermined concentrations, 2,000 ppm of sodium nitrate, 1,500 ppm of 40% silicofluoric acid, 15 ppm of ferric nitrate nonahydrate and sodium nitrite corresponding to 140 ppm of nitrite ions were added, and the pH was adjusted to three steps of 3.6, 4.0 and 4.4 with sodium hydroxide, before warming to 40° C. Fluorine ion concentrations of the present treatment liquid were 68 ppm at pH 3.6, 77 ppm at pH 4.0 and 83 ppm at pH 4.4, regardless of the concentrations of phosphate and zinc ions, as determined by a fluorine ion meter.

The stabilities of the adjusted zinc phosphate chemical conversion treatment liquids were determined according to appearance. Determination criteria were as follows:

: no sludge observed

◯: minimal sludge observed

Δ: slight sludge observed

x: apparent sludge generated with white turbidity

For the treatment liquids determined as x, evaluation was terminated at that point, while for the treatment liquids with the results , ◯ and Δ, metallic materials were subsequently treated with them.

Cold-rolled steel sheets SPCC (JIS 3141) 70×150×0.8 mm (abbreviated as SPC hereinafter), as a metallic material, were degreased in advance by spraying the surface for 120 seconds with FC-E 2001, a strongly alkaline degreasing agent manufactured by Nihon Parkerizing Co., Ltd. After degreasing, spray water rinsing was carried out for 30 seconds and then surface conditioning treatment was carried out by dipping for 30 seconds, immediately followed by zinc phosphate chemical conversion treatment by dipping for 90 seconds. Thereafter, water rinsing was carried out by spraying for 30 seconds and attached water was dried off in an electric oven at 90° C. for 180 seconds.

For surface conditioning treatment, PREPALENE XG (abbreviated as PL-XG) a surface conditioning agent manufactured by Nihon Parkerizing Co., Ltd. and Additive 4977 (abbreviated as AD-4977) an alkali additive were used for conditioning to a concentration of fine zinc phosphate particles of 300 ppm and the pH of 9.0. The treatment was carried out at normal temperature without warming.

Quantitative and qualitative determinations on the deposited coatings were carried out. First, as quantitative determinations, the amounts of deposited zinc phosphate coating were calculated based on the determination of the amount of deposited Zn by X-ray fluorescence spectrometry. Determination criteria were as follows:

: 1.5 g/m² or more

◯: less than 1.5 g/m² and 1.0 g/m² or more

Δ: less than 1.0 g/m² and 0.7 g/m² or more

x: less than 0.7 g/m²

For the treatment liquids determined as x, evaluation was terminated at that point, while for the coatings with the results , ◯ and Δ, qualitative determinations were continued. Qualitative determinations determined the contents of zinc iron phosphate in the coatings. Zinc phosphate (Hopeite) and zinc iron phosphate (Phosphophyllite) coexist in zinc phosphate film crystals formed on steel materials and it is known from previous knowledge that the higher the content of zinc iron phosphate, the better the coating performances may be. Details are described in a known literature 1 (T. Miyawaki, H. Okita, S. Umehara and M. Okabe: Proceedings of Interfinish '80 30, 3 (1980)).

In a manner similar to the known literature 1, the contents of zinc iron phosphate in the coatings were determined. Determination criteria were as follows:

90% or more

◯: less than 90% and 80% or more

Δ: less than 80% and 70% or more

x: less than 70%

Ten SPCs were treated with 5.0 L of the treatment liquid, and the whole amount of the treatment liquid after treatment was suction-filtered through a membrane filter having a pore size of 1 μm to collect sludge generated by the treatment. After washing the sludge with a small amount of pure water, the filter with the sludge was introduced into an electric oven and dried at 90° C. for two hours. The filter with the sludge after drying was weighed and the weight of the filter before testing was subtracted to determine the weight of the generated sludge. The amounts of generated sludge were evaluated according to the evaluation criteria as follows:

: less than 0.2 g

◯: less than 0.3 g and 0.2 g or more

Δ: less than 0.4 g and 0.3 g or more

x: 0.4 g or more

The results of the quantitative and qualitative determinations of the phosphate ion and zinc ion concentrations in the treatment liquid, the coefficients K, the treatment liquid stabilities, the amounts of generated sludge and the deposited coatings are shown in Tables 1 to 3. Comprehensive evaluation results of three evaluation items are also provided in the Tables. The lowest evaluation among the three items was considered a comprehensive evaluation. When plural Δs were given, however, the comprehensive evaluation was degraded to x.

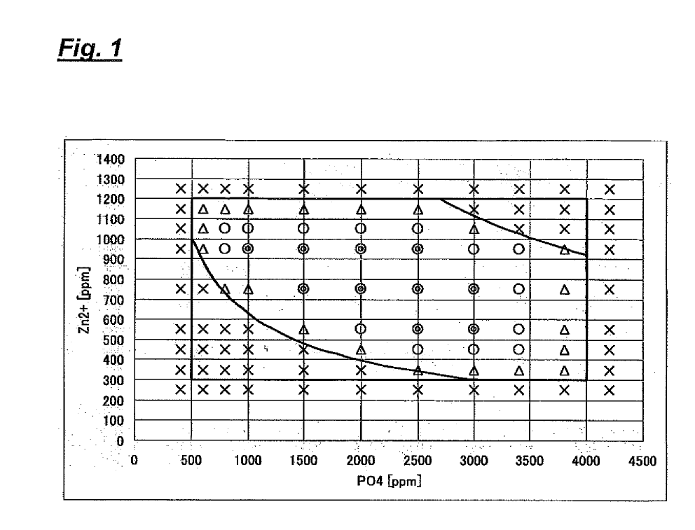

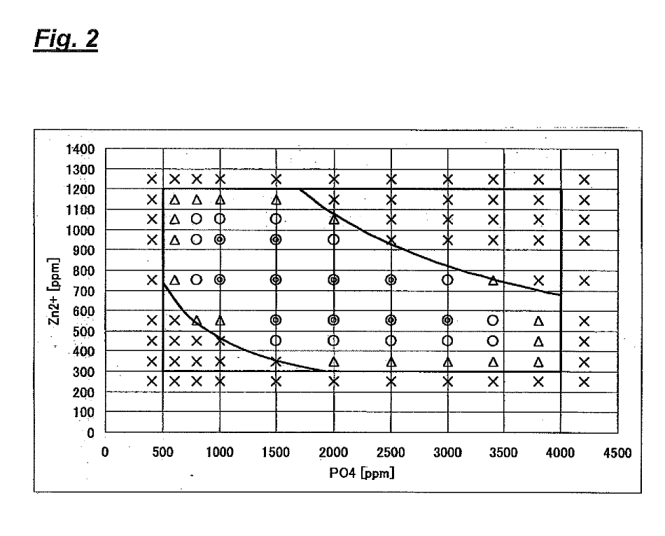

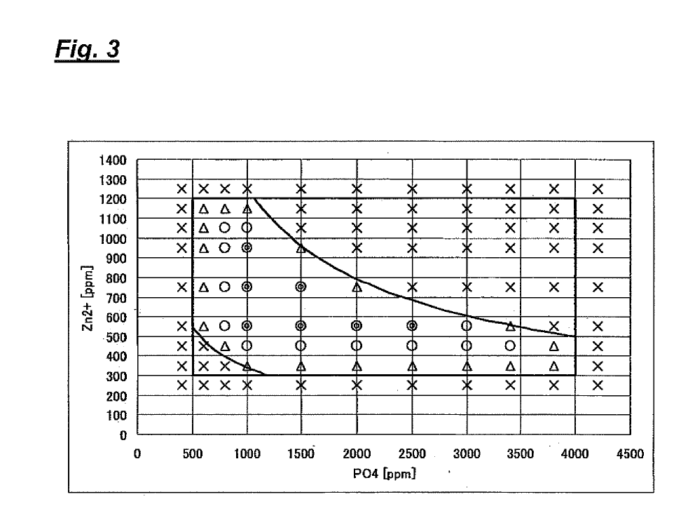

Further, FIGS. 1 to 3 show graphs showing phosphate ion and zinc ion concentrations along X and Y axes, with comprehensive evaluation results plotted at respective locations. Also, the upper and lower limits of phosphate ion and zinc ion concentrations are shown in the figures in consideration of the coefficient K. Table 1 and FIG. 1 correspond to pH 3.6, Table 2 and FIG. 2 correspond to pH 4.0 and Table 3 and FIG. 3 correspond to pH 4.4.

As apparent from Tables 1 to 3 and FIGS. 1 to 3, the treatment liquids according to the present invention possess sufficient stability and the metallic materials subjected zinc phosphate chemical conversion treatment with the treatment liquids and the processes for treatment according to the present invention possess sufficient amount and quality of coatings.

Next, as Experiment 2, parameters other than phosphate ion and zinc ions were examined. Phosphate ion and zinc ion concentrations in the treatment liquids, coefficients K, treatment liquid pH, temperatures, coating chemical conversion accelerators and added metals are listed in Table 2. The treatment liquids were prepared as follows.

Using 75% phosphoric acid and zinc nitrate, phosphate ions and zinc ions were added at predetermined concentrations, 500 ppm of 40% silicofluoric acid, 55% hydrofluoric acid, 15 ppm of ferric nitrate nonahydrate and, when metals other than zinc were added, a predetermined amount of the metal as a nitrate salt were added. When nitrite ion (NO₂) was used as the coating chemical conversion accelerator, a predetermined amount of sodium nitrite was added or when hydroxylamine (HA) was used as the coating chemical conversion accelerator, a predetermined amount of hydroxylamine sulfate was added and pH was adjusted with sodium hydroxide, before warming to a predetermined temperature. Fluorine ion concentration was adjusted by the added amount of 55% hydrofluoric acid.

For Comparative Examples 5 and 6, no fluorine component was added and ORP was adjusted to 200 mV with the addition of ferrous sulfate. For Comparative Example 7, the added amount of ferric nitrate nonahydrate was adjusted so that 100 ppm of ferric ions may be provided. Also, for a fluorine component, 40% silicofluoric acid was added so that 800 ppm of SiF6 may be obtained and free acidity, instead of pH, of the treatment liquid was adjusted to 0.8. For Comparative Example 8, sodium hydrogen fluoride was added as a fluorine component and the free fluorine concentration was adjusted to 580 ppm.

Basically, Comparative Example 5 corresponded to the treatment liquid in Example 4 of Patent Reference 2, Comparative Example 6 corresponded to the treatment liquid in Comparative Example 5 elevated in temperature to 40° C., Comparative Example 7 corresponded to the treatment liquid in Example 1 of Patent Reference 17 and Comparative Example 8 corresponded to the treatment liquid in Example 5 of Patent Reference 16.

The stability of each adjusted zinc phosphate chemical conversion treatment liquid was initially determined according to appearance. Determination criteria were as follows:

: no sludge observed

◯: minimal sludge observed

Δ: slight sludge observed

x: apparent sludge generated with white turbidity

For the treatment liquids determined as x, evaluation was terminated at that point, while for the treatment liquids with the results , ◯ and Δ, metallic materials were subsequently treated with them.

As metallic materials in Experiment 2, SPC and alloyed hot-dip galvanized steel sheets SGCC F06 MO (JISG 3302) 70×150×0.8 mm (abbreviated as GA hereinafter) were used. The surfaces of the materials were degreased in advance by spraying the surfaces for 120 seconds with FC-E 2001, a strongly alkaline degreasing agent manufactured by Nihon Parkerizing Co., Ltd. After degreasing, spray water rinsing was carried out for 30 seconds and then surface conditioning treatment was carried out by dipping for 30 seconds, immediately followed by zinc phosphate chemical conversion treatment by dipping for 90 seconds. Thereafter, water rinsing was carried out by spraying for 30 seconds and attached water was dried off in an electric oven at 90° C. for 180 seconds.

For surface conditioning treatment, PREPALENE XG (abbreviated as PL-XG) a zinc phosphate-based surface conditioning agent manufactured by Nihon Parkerizing Co., Ltd. or PREPALENE ZN (abbreviated as PL-ZN) a titanium phosphate-based surface conditioning agent manufactured by Nihon Parkerizing Co., Ltd. was used. For PL-XG, pH was adjusted to 9.0 using AD-4977 in combination. Concentration of PL-XG was adjusted so that the fine zinc phosphate particle concentrations listed in Table 2 may be obtained. Concentration of PL-ZN was 1,000 ppm. Treatment was carried out at normal temperature without warming.

For Example 9, without carrying out degreasing or surface conditioning treatment, the chemical conversion liquid used in Example 8 was used with the addition of 500 ppm of NEWPOL PE-68, a nonionic surface active agent manufactured by Sanyo Chemical Industries, Ltd. to directly dip SPC and GA for 90 seconds. Thereafter water rinsing was carried out by spraying for 30 seconds and attached water was dried off in an electric oven at 90° C. for 180 seconds.

Evaluation of the amount of the coating deposited on each metallic material was carried out. The amount of the coating deposited on SPC was calculated based on the quantitative value of the amount of deposited Zn by X-ray fluorescence spectrometry and the amount of the coating deposited on GA was also calculated based on the quantitative value of the amount of deposited P by X-ray fluorescence spectrometry. The calculated amounts of the deposited coatings were evaluated according to the evaluation criteria as follows.

Coatings over SPC
: 1.5 g/m² or more
◯: less than 1.5 g/m² and 1.0 g/m² or more
Δ: less than 1.0 g/m² and 0.7 g/m² or more
x: less than 0.7 g/m²

Coatings over GA
: 2.5 g/m² or more
◯: less than 2.5 g/m² and 2.0 g/m² or more
Δ: less than 2.0 g/m² and 1.5 g/m² or more
x: less than 1.5 g/m²

Ten SPCs were treated with 5.0 L of the treatment liquid, and the whole amount of the treatment liquid after treatment was suction-filtered through a membrane filter having a pore size of 1 μm to collect sludge generated by the treatment. After washing the sludge with a small amount of pure water, the filter with the sludge was introduced into an electric oven and dried at 90° C. for two hours. The filter with the sludge after drying was weighed and the weight of the filter before testing was subtracted to determine the weight of the generated sludge. The amounts of the generated sludge were evaluated according to the evaluation criteria as follows:

: less than 0.2 g

◯: less than 0.3 g and 0.2 g or more

Δ: less than 0.4 g and 0.3 g or more

x: 0.4 g or more

As practical evaluation of coating quality, metallic materials after chemical conversion treatment were electrodeposition-coated and solvent-coated to evaluate corrosion resistance after coating. Methods for coating and methods for evaluating corrosion resistance are as follows.

### Electrodeposition Coating

GT-10 HT manufactured by Kansai Paint Co., Ltd. was used as an electrodeposition paint. Using a stainless sheet (SUS 304) as the anode, cold-rolled steel sheets were subjected to potentiostatic cathodic electrolysis for 180 seconds to deposit a coated film over the whole surface of the metallic sheet, followed by water rinsing and heated baking at 170° C. for 20 minutes to form a coated film. Coated film thickness was adjusted to 20 μm by variable voltage control.

### Solvent Coating

MAGICRON 1000 manufactured by Kansai Paint Co., Ltd. was used as a solvent-based paint. Spray coating was carried out to be to a dry film thickness of 30 μm, followed by baking at 160° C. for 20 minutes.

### Method for Evaluating Corrosion Resistance

Crosscutting was made on the coated sheets with a cutter knife and then salt water spray testing (JIS-Z 2371) was carried out to measure the blister width at one side of the crosscut portions after 1,000 hours. The results of the measurement were evaluated according to the evaluation criteria as follows:

: less than 2.5 mm

◯: less than 3.5 mm and 2.5 mm or more

Δ: less than 4.5 mm and 6.0 mm or more

x: 6.0 mm or more

The surface conditioning conditions, the chemical conversion liquid properties, the treatment liquid stabilities, the amounts of generated sludge, the amounts of coating and the coating performances of Examples and Comparative Examples of Experiment 2 are all included in Table 2.

As apparent from Table 2, it is understood that Examples 1 to 8 with the use of the treatment liquids according to the present invention represent an epoch-making technique capable not only of providing zinc phosphate chemical conversion treated coatings exhibiting excellent coating performances and but also of remarkably reducing the amount of generated sludge as a problem to be solved.

On the contrary, Comparative Example 1 where treatment liquid pH is too high and Comparative Example 3 where treatment temperature is too high will generate a huge amount of sludge at the stage for conditioning the treatment liquids and Comparative Example 2 where treatment liquid pH is too low and Comparative Example 4 where treatment temperature is too low will secure treatment liquid stability but fail to inhibit sludge generation caused by the treatment and to provide a sufficient amount of coating for exhibiting coating performances.

Also for Comparative Examples 5 to 8 as the prior art, it is understood that they are not techniques that are capable of satisfying all of treatment liquid stability, sludge generation reduction effects and coating performances. For Comparative Example 1, although the treatment liquid pH is high, the treatment temperature is so low that sufficient chemical conversion treatability and coating performances may not be obtained and when Comparative Example 1 is increased in temperature, treatment liquid stability will be impaired as in Comparative Example 2. Comparative Example 7 has too low a pH of the treatment liquid and Comparative Example 8 has a high pH but is contaminated with a large amount of free fluorine as an etchant. Therefore, they may not reduce the amount of generated sludge.

TABLE 1
Table 1 Examples and Comparative Examples (for treatment liquid pH 3.6)

| Ion | | | | | | | |
|---|---|---|---|---|---|---|---|
| concentrations | | | Treatment | | | | |
| (ppm) | | | liquid | Coating | | | Comprehensive |
| PO4 | Zn | Coefficients K | stabilities | Amounts | Qualities | Sludge | evaluations |
| 400 | 250 | 0.01 | | x | — | Δ | x |
| 400 | 350 | 0.03 | | x | — | Δ | x |
| 400 | 450 | 0.06 | | x | — | Δ | x |
| 400 | 550 | 0.11 | | x | — | Δ | x |
| 400 | 750 | 0.27 | | x | — | Δ | x |
| 400 | 950 | 0.55 | | x | — | Δ | x |
| 400 | 1050 | 0.74 | | x | — | Δ | x |
| 400 | 1150 | 0.97 | | x | — | ∘ | x |
| 400 | 1250 | 1.24 | | x | — | ∘ | x |
| 600 | 250 | 0.02 | | x | — | Δ | x |
| 600 | 350 | 0.06 | | x | — | Δ | x |
| 600 | 450 | 0.13 | | x | — | Δ | x |
| 600 | 550 | 0.24 | | x | — | Δ | x |
| 600 | 750 | 0.60 | | x | — | Δ | x |
| 600 | 950 | 1.23 | | Δ | ∘ | ∘ | Δ |
| 600 | 1050 | 1.66 | | Δ | ∘ | ∘ | Δ |
| 600 | 1150 | 2.18 | | Δ | ∘ | ∘ | Δ |
| 600 | 1250 | 2.80 | | Δ | Δ | ∘ | x |
| 800 | 250 | 0.04 | | x | — | Δ | x |
| 800 | 350 | 0.11 | | x | — | Δ | x |
| 800 | 450 | 0.23 | | x | — | Δ | x |
| 800 | 550 | 0.42 | | x | — | Δ | x |
| 800 | 750 | 1.07 | | Δ | ∘ | ∘ | Δ |
| 800 | 950 | 2.18 | | ∘ | ∘ | ∘ | ∘ |
| 800 | 1050 | 2.95 | | ∘ | ∘ | ∘ | ∘ |
| 800 | 1150 | 3.88 | | ∘ | Δ | ∘ | Δ |
| 800 | 1250 | 4.98 | | Δ | Δ | ∘ | x |
| 1000 | 250 | 0.06 | | x | — | Δ | x |
| 1000 | 350 | 0.17 | | x | — | Δ | x |
| 1000 | 450 | 0.36 | | x | — | Δ | x |
| 1000 | 550 | 0.66 | | x | — | Δ | x |
| 1000 | 750 | 1.68 | | Δ | ∘ | ∘ | Δ |
| 1000 | 950 | 3.41 | | | | | |
| 1000 | 1050 | 4.61 | | | ∘ | | ∘ |
| 1000 | 1150 | 6.05 | | | Δ | | Δ |
| 1000 | 1250 | 7.78 | | | x | | x |
| 1500 | 250 | 0.14 | | x | — | Δ | x |
| 1500 | 350 | 0.38 | | x | — | Δ | x |
| 1500 | 450 | 0.82 | | x | — | Δ | x |
| 1500 | 550 | 1.49 | | Δ | | ∘ | Δ |
| 1500 | 750 | 3.78 | | | | | |
| 1500 | 950 | 7.68 | | | | | |
| 1500 | 1050 | 10.37 | | | ∘ | | ∘ |
| 1500 | 1150 | 13.62 | | | Δ | | Δ |
| 1500 | 1250 | 17.49 | | | x | | x |
| 2000 | 250 | 0.25 | | x | — | Δ | x |
| 2000 | 350 | 0.68 | | x | — | Δ | x |
| 2000 | 450 | 1.45 | | Δ | | ∘ | Δ |
| 2000 | 550 | 2.65 | | ∘ | | ∘ | ∘ |
| 2000 | 750 | 6.72 | | | | | |
| 2000 | 950 | 13.65 | | | | | |
| 2000 | 1050 | 18.43 | | | ∘ | | ∘ |
| 2000 | 1150 | 24.22 | | | Δ | | Δ |
| 2000 | 1250 | 31.10 | ∘ | | x | | x |
| 2500 | 250 | 0.39 | | x | — | Δ | x |
| 2500 | 350 | 1.07 | | Δ | ∘ | ∘ | Δ |
| 2500 | 450 | 2.27 | | ∘ | | ∘ | ∘ |
| 2500 | 550 | 4.14 | | | | | |
| 2500 | 750 | 10.50 | | | | | |
| 2500 | 950 | 21.33 | | | | | |
| 2500 | 1050 | 28.80 | | | ∘ | | ∘ |
| 2500 | 1150 | 37.84 | | | Δ | ∘ | Δ |
| 2500 | 1250 | 48.60 | ∘ | | x | ∘ | x |
| 3000 | 250 | 0.56 | | x | — | Δ | x |
| 3000 | 350 | 1.54 | | Δ | | ∘ | Δ |
| 3000 | 450 | 3.26 | | ∘ | | ∘ | ∘ |
| 3000 | 550 | 5.96 | | | | | |
| 3000 | 750 | 15.12 | | | | | |
| 3000 | 950 | 30.72 | ∘ | | ∘ | | ∘ |
| 3000 | 1050 | 41.48 | Δ | | ∘ | ∘ | Δ |
| 3000 | 1150 | 54.49 | x | — | — | — | x |
| 3000 | 1250 | 69.98 | x | — | — | — | x |
| 3400 | 250 | 0.72 | | x | — | Δ | x |
| 3400 | 350 | 1.97 | | Δ | | ∘ | Δ |
| 3400 | 450 | 4.19 | | ∘ | | | ∘ |
| 3400 | 550 | 7.66 | | ∘ | | | ∘ |
| 3400 | 750 | 19.42 | | ∘ | | | ∘ |
| 3400 | 950 | 39.46 | ∘ | ∘ | ∘ | ∘ | ∘ |
| 3400 | 1050 | 53.28 | x | — | — | — | x |
| 3400 | 1150 | 69.99 | x | — | — | — | x |
| 3400 | 1250 | 89.89 | x | — | — | — | x |
| 3800 | 250 | 0.90 | | x | — | Δ | x |
| 3800 | 350 | 2.46 | | Δ | ∘ | ∘ | Δ |
| 3800 | 450 | 5.24 | | Δ | ∘ | | Δ |
| 3800 | 550 | 9.56 | | ∘ | Δ | | Δ |
| 3800 | 750 | 24.25 | | ∘ | Δ | | Δ |
| 3800 | 950 | 49.29 | Δ | ∘ | Δ | ∘ | Δ |
| 3800 | 1050 | 66.55 | x | — | — | — | x |
| 3800 | 1150 | 87.43 | x | — | — | — | x |
| 3800 | 1250 | 112.28 | x | — | — | — | x |
| 4200 | 250 | 1.10 | | Δ | | Δ | x |
| 4200 | 350 | 3.01 | | Δ | ∘ | Δ | x |
| 4200 | 450 | 6.40 | | Δ | Δ | ∘ | x |
| 4200 | 550 | 11.68 | | Δ | Δ | ∘ | x |
| 4200 | 750 | 29.63 | | ∘ | x | ∘ | x |
| 4200 | 950 | 60.21 | x | — | — | — | x |
| 4200 | 1050 | 81.30 | x | — | — | — | x |
| 4200 | 1150 | 106.81 | x | — | — | — | x |
| 4200 | 1250 | 137.16 | x | — | — | — | x |

TABLE 2
Table 2 Examples and Comparative Examples (for treatment liquid pH 4.0)

| Ion | | | | | | | |
|---|---|---|---|---|---|---|---|
| concentrations | | | Treatment | | | | |
| (ppm) | | | liquid | Coating | | | Comprehensive |
| PO4 | Zn | Coefficients K | stabilities | Amounts | Qualities | Sludge | evaluations |
| 400 | 250 | 0.03 | | x | — | ∘ | x |
| 400 | 350 | 0.07 | | x | — | ∘ | x |
| 400 | 450 | 0.15 | | x | — | ∘ | x |
| 400 | 550 | 0.27 | | x | — | ∘ | x |
| 400 | 750 | 0.68 | | x | — | ∘ | x |
| 400 | 950 | 1.37 | | x | — | ∘ | x |
| 400 | 1050 | 1.85 | | x | — | ∘ | x |
| 400 | 1150 | 2.43 | | x | — | ∘ | x |
| 400 | 1250 | 3.13 | | x | — | ∘ | x |
| 600 | 250 | 0.06 | | x | — | ∘ | x |
| 600 | 350 | 0.15 | | x | — | ∘ | x |
| 600 | 450 | 0.33 | | x | — | ∘ | x |
| 600 | 550 | 0.60 | | x | — | ∘ | x |
| 600 | 750 | 1.52 | | Δ | | ∘ | Δ |
| 600 | 950 | 3.09 | | Δ | | ∘ | Δ |
| 600 | 1050 | 4.17 | | Δ | | | Δ |
| 600 | 1150 | 5.48 | | Δ | ∘ | | Δ |
| 600 | 1250 | 7.03 | | Δ | Δ | | x |
| 800 | 250 | 0.10 | | x | — | ∘ | x |
| 800 | 350 | 0.27 | | x | — | ∘ | x |
| 800 | 450 | 0.58 | | x | — | ∘ | x |
| 800 | 550 | 1.06 | | Δ | | ∘ | Δ |
| 800 | 750 | 2.70 | | ∘ | | ∘ | ∘ |
| 800 | 950 | 5.49 | | ∘ | | | ∘ |
| 800 | 1050 | 7.41 | | ∘ | | | ∘ |
| 800 | 1150 | 9.73 | | | Δ | ∘ | Δ |
| 800 | 1250 | 12.50 | | | Δ | Δ | x |
| 1000 | 250 | 0.16 | | x | — | ∘ | x |
| 1000 | 350 | 0.43 | | x | — | ∘ | x |
| 1000 | 450 | 0.91 | | x | — | ∘ | x |
| 1000 | 550 | 1.66 | | Δ | | | Δ |
| 1000 | 750 | 4.22 | | | | | |
| 1000 | 950 | 8.57 | | | | | |
| 1000 | 1050 | 11.58 | | | ∘ | | ∘ |
| 1000 | 1150 | 15.21 | | | Δ | ∘ | Δ |
| 1000 | 1250 | 19.53 | | | Δ | Δ | x |
| 1500 | 250 | 0.35 | | x | — | ∘ | x |
| 1500 | 350 | 0.96 | | x | — | ∘ | x |
| 1500 | 450 | 2.05 | | ∘ | | | ∘ |
| 1500 | 550 | 3.74 | | | | | |
| 1500 | 750 | 9.49 | | | | | |
| 1500 | 950 | 19.29 | | | | | |
| 1500 | 1050 | 26.05 | | | ∘ | | ∘ |
| 1500 | 1150 | 34.22 | ∘ | | Δ | ∘ | Δ |
| 1500 | 1250 | 43.95 | Δ | | Δ | Δ | x |
| 2000 | 250 | 0.63 | | x | — | ∘ | x |
| 2000 | 350 | 1.72 | | Δ | | ∘ | Δ |
| 2000 | 450 | 3.65 | | ∘ | | | ∘ |
| 2000 | 550 | 6.66 | | | | | |
| 2000 | 750 | 16.88 | | | | | |
| 2000 | 950 | 34.30 | ∘ | | | ∘ | ∘ |
| 2000 | 1050 | 46.31 | Δ | | ∘ | ∘ | Δ |
| 2000 | 1150 | 60.84 | x | — | — | — | x |
| 2000 | 1250 | 78.13 | x | — | — | — | x |
| 2500 | 250 | 0.98 | | x | — | ∘ | x |
| 2500 | 350 | 2.68 | | Δ | | | Δ |
| 2500 | 450 | 5.70 | | ∘ | | | ∘ |
| 2500 | 550 | 10.40 | | | | | |
| 2500 | 750 | 26.37 | | | | | |
| 2500 | 950 | 53.59 | x | — | — | — | x |
| 2500 | 1050 | 72.35 | x | — | — | — | x |
| 2500 | 1150 | 95.05 | x | — | — | — | x |
| 2500 | 1250 | 122.07 | x | — | — | — | x |
| 3000 | 250 | 1.41 | | x | — | ∘ | x |
| 3000 | 350 | 3.86 | | Δ | | | Δ |
| 3000 | 450 | 8.20 | | ∘ | | | ∘ |
| 3000 | 550 | 14.97 | | | | | |
| 3000 | 750 | 37.97 | ∘ | | | ∘ | ∘ |
| 3000 | 950 | 77.16 | x | — | — | — | x |
| 3000 | 1050 | 104.19 | x | — | — | — | x |
| 3000 | 1150 | 136.88 | x | — | — | — | x |
| 3000 | 1250 | 175.78 | x | — | — | — | x |
| 3400 | 250 | 1.81 | | x | — | ∘ | x |
| 3400 | 350 | 4.96 | | Δ | | | Δ |
| 3400 | 450 | 10.53 | | ∘ | | | ∘ |
| 3400 | 550 | 19.23 | | ∘ | | | ∘ |
| 3400 | 750 | 48.77 | Δ | ∘ | | ∘ | Δ |
| 3400 | 950 | 99.11 | x | — | — | — | x |
| 3400 | 1050 | 133.82 | x | — | — | — | x |
| 3400 | 1150 | 175.81 | x | — | — | — | x |
| 3400 | 1250 | 225.78 | x | — | — | — | x |
| 3800 | 250 | 2.26 | | x | — | ∘ | x |
| 3800 | 350 | 6.19 | | Δ | | | Δ |
| 3800 | 450 | 13.16 | | Δ | | | Δ |
| 3800 | 550 | 24.02 | | Δ | | | Δ |
| 3800 | 750 | 60.92 | x | — | — | — | x |
| 3800 | 950 | 123.80 | x | — | — | — | x |
| 3800 | 1050 | 167.16 | x | — | — | — | x |
| 3800 | 1150 | 219.61 | x | — | — | — | x |
| 3800 | 1250 | 282.03 | x | — | — | — | x |
| 4200 | 250 | 2.76 | | x | — | | x |
| 4200 | 350 | 7.56 | | x | — | | x |
| 4200 | 450 | 16.07 | | x | — | | x |
| 4200 | 550 | 29.35 | | Δ | Δ | | x |
| 4200 | 750 | 74.42 | x | — | — | — | x |
| 4200 | 950 | 151.24 | x | — | — | — | x |
| 4200 | 1050 | 204.21 | x | — | — | — | x |
| 4200 | 1150 | 268.28 | x | — | — | — | x |
| 4200 | 1250 | 344.53 | x | — | — | — | x |

TABLE 3
Table 3 Examples and Comparative Examples (for treatment liquid pH 4.4)

| Ion | | | | | | | |
|---|---|---|---|---|---|---|---|
| concentrations | | | Treatment | | | | |
| (ppm) | | | liquid | Coating | | | Comprehensive |
| PO4 | Zn | Coefficients K | stabilities | Amounts | Qualities | Sludge | evaluations |
| 400 | 250 | 0.06 | | x | — | ∘ | x |
| 400 | 350 | 0.17 | | x | — | ∘ | x |
| 400 | 450 | 0.37 | | x | — | ∘ | x |
| 400 | 550 | 0.67 | | x | — | | x |
| 400 | 750 | 1.70 | | x | — | | x |
| 400 | 950 | 3.45 | | x | — | | x |
| 400 | 1050 | 4.65 | | x | — | | x |
| 400 | 1150 | 6.11 | | x | — | | x |
| 400 | 1250 | 7.85 | | x | — | | x |
| 600 | 250 | 0.14 | | x | — | ∘ | x |
| 600 | 350 | 0.39 | | x | — | ∘ | x |
| 600 | 450 | 0.82 | | x | — | | x |
| 600 | 550 | 1.50 | | Δ | | | Δ |
| 600 | 750 | 3.81 | | Δ | ∘ | | Δ |
| 600 | 950 | 7.75 | | ∘ | Δ | | Δ |
| 600 | 1050 | 10.47 | | ∘ | Δ | | Δ |
| 600 | 1150 | 13.75 | | ∘ | Δ | | Δ |
| 600 | 1250 | 17.66 | | ∘ | x | | x |
| 800 | 250 | 0.25 | | x | — | | x |
| 800 | 350 | 0.69 | | x | — | | x |
| 800 | 450 | 1.46 | | Δ | | | Δ |
| 800 | 550 | 2.67 | | ∘ | | | ∘ |
| 800 | 750 | 6.78 | | ∘ | | | ∘ |
| 800 | 950 | 13.78 | | ∘ | ∘ | | ∘ |
| 800 | 1050 | 18.61 | | ∘ | ∘ | | ∘ |
| 800 | 1150 | 24.45 | | ∘ | Δ | | Δ |
| 800 | 1250 | 31.40 | ∘ | ∘ | x | | x |
| 1000 | 250 | 0.39 | | x | — | | x |
| 1000 | 350 | 1.08 | | Δ | | | Δ |
| 1000 | 450 | 2.29 | | ∘ | | | ∘ |
| 1000 | 550 | 4.18 | | | | | |
| 1000 | 750 | 10.60 | | | | | |
| 1000 | 950 | 21.54 | | | | | |
| 1000 | 1050 | 29.08 | | | ∘ | | ∘ |
| 1000 | 1150 | 38.20 | ∘ | | Δ | | Δ |
| 1000 | 1250 | 49.06 | Δ | | x | ∘ | x |
| 1500 | 250 | 0.88 | | x | — | ∘ | x |
| 1500 | 350 | 2.42 | | Δ | | | Δ |
| 1500 | 450 | 5.15 | | ∘ | | | ∘ |
| 1500 | 550 | 9.40 | | | | | |
| 1500 | 750 | 23.84 | | | | | |
| 1500 | 950 | 48.46 | Δ | | ∘ | ∘ | Δ |
| 1500 | 1050 | 65.43 | x | — | — | — | x |
| 1500 | 1150 | 85.96 | x | — | — | — | x |
| 1500 | 1250 | 110.39 | x | — | — | — | x |
| 2000 | 250 | 1.57 | | x | — | | x |
| 2000 | 350 | 4.31 | | Δ | | | Δ |
| 2000 | 450 | 9.16 | | ∘ | | | ∘ |
| 2000 | 550 | 16.72 | | | | | |
| 2000 | 750 | 42.39 | Δ | | | ∘ | Δ |
| 2000 | 950 | 86.15 | x | — | — | — | x |
| 2000 | 1050 | 116.31 | x | — | — | — | x |
| 2000 | 1150 | 152.81 | x | — | — | — | x |
| 2000 | 1250 | 196.24 | x | — | — | — | x |
| 2500 | 250 | 2.45 | | x | — | | x |
| 2500 | 350 | 6.73 | | Δ | | | Δ |
| 2500 | 450 | 14.31 | | ∘ | | | ∘ |
| 2500 | 550 | 26.12 | | | | | |
| 2500 | 750 | 66.23 | x | — | — | — | x |
| 2500 | 950 | 134.60 | x | — | — | — | x |
| 2500 | 1050 | 181.74 | x | — | — | — | x |
| 2500 | 1150 | 238.77 | x | — | — | — | x |
| 2500 | 1250 | 306.63 | x | — | — | — | x |
| 3000 | 250 | 3.53 | | x | — | | x |
| 3000 | 350 | 9.69 | | Δ | | | Δ |
| 3000 | 450 | 20.60 | | ∘ | | | ∘ |
| 3000 | 550 | 37.61 | ∘ | ∘ | | | ∘ |
| 3000 | 750 | 95.37 | x | — | — | — | x |
| 3000 | 950 | 193.83 | x | — | — | — | x |
| 3000 | 1050 | 261.70 | x | — | — | — | x |
| 3000 | 1150 | 343.82 | x | — | — | — | x |
| 3000 | 1250 | 441.54 | x | — | — | — | x |
| 3400 | 250 | 4.54 | | x | — | | x |
| 3400 | 350 | 12.45 | | Δ | | | Δ |
| 3400 | 450 | 26.46 | | ∘ | | | ∘ |
| 3400 | 550 | 48.31 | Δ | ∘ | | ∘ | Δ |
| 3400 | 750 | 122.50 | x | — | — | — | x |
| 3400 | 950 | 248.96 | x | — | — | — | x |
| 3400 | 1050 | 336.14 | x | — | — | — | x |
| 3400 | 1150 | 441.62 | x | — | — | — | x |
| 3400 | 1250 | 567.14 | x | — | — | — | x |
| 3800 | 250 | 5.67 | | x | — | | x |
| 3800 | 350 | 15.55 | | Δ | — | | Δ |
| 3800 | 450 | 33.05 | ∘ | Δ | — | | Δ |
| 3800 | 550 | 60.35 | x | — | — | — | x |
| 3800 | 750 | 153.02 | x | — | — | — | x |
| 3800 | 950 | 310.98 | x | — | — | — | x |
| 3800 | 1050 | 419.89 | x | — | — | — | x |
| 3800 | 1150 | 551.65 | x | — | — | — | x |
| 3800 | 1250 | 708.43 | x | — | — | — | x |
| 4200 | 250 | 6.92 | | x | — | | x |
| 4200 | 350 | 19.00 | | x | — | | x |
| 4200 | 450 | 40.38 | Δ | Δ | — | ∘ | x |
| 4200 | 550 | 73.72 | x | — | — | — | x |
| 4200 | 750 | 186.93 | x | — | — | — | x |
| 4200 | 950 | 379.90 | x | — | — | — | x |
| 4200 | 1050 | 512.94 | x | — | — | — | x |
| 4200 | 1150 | 673.89 | x | — | — | — | x |
| 4200 | 1250 | 865.42 | x | — | — | — | x |

TABLE 4

| Examples | | | Chemical convension treatment solution properties | | | | | | |
|---|---|---|---|---|---|---|---|---|---|
| and | Surface conditioning | | Ion concentrations | | | | | | |
| Comparative | | Particle | (ppm) | | | | Treatment | Temperatures | Coating |
| Examples | Chemicals | concentrations | PO4 | Zn | F | Coefficients K | solution pH | (° C.) | accelerators |
| Example 1 | PL-XG | 300 ppm | 2000 | 900 | 23 | 11.6 | 3.6 | 45 | NO2: 100 ppm |
| Example 2 | PL-XG | 300 ppm | 1500 | 600 | 220 | 12.2 | 4.4 | 37 | HA: 1500 ppm |
| Example 3 | PL-XG | 300 ppm | 1500 | 1000 | 100 | 35.7 | 4.2 | 32 | NO2: 200 ppm |
| Example 4 | PL-XG | 300 ppm | 2000 | 500 | 100 | 2.5 | 3.7 | 55 | NO2: 140 ppm |
| Example 5 | PL-XG | 300 ppm | 2000 | 600 | 150 | 8.6 | 4.0 | 45 | NO2: 140 ppm |
| Example 6 | PL-XG | 300 ppm | 2400 | 700 | 50 | 12.5 | 3.8 | 37 | HA: 1000 ppm |
| Example 7 | PL-XG | 120 ppm | 2500 | 500 | 100 | 6.2 | 3.9 | 40 | NO2: 140 ppm |
| Example 8 | PL-XG | 1500 ppm | 1600 | 800 | 100 | 13.1 | 4.0 | 40 | NO2: 140 ppm |
| Example 9 | — | — | 1600 | 800 | 100 | 13.1 | 4.0 | 40 | NO2: 140 ppm |
| Com. Example 1 | PL-XG | 300 ppm | 2000 | 750 | 100 | 53.4 | 4.5 | 45 | NO2: 140 ppm |
| Com. Example 2 | PL-XG | 300 ppm | 1500 | 500 | 100 | 0.9 | 3.5 | 37 | HA: 1500 ppm |
| Com. Example 3 | PL-XG | 300 ppm | 1500 | 1000 | 100 | 44.9 | 4.3 | 65 | NO2: 140 ppm |
| Com. Example 4 | PL-XG | 300 ppm | 2000 | 500 | 100 | 2.5 | 3.7 | 27 | NO2: 140 ppm |
| Com. Example 5 | PL-ZN | — | 3000 | 1000 | 0 | 71.5 | 3.9 | 22 | NO2: 80 ppm |
| Com. Example 6 | PL-ZN | — | 3000 | 1000 | 0 | 71.5 | 3.9 | 40 | NO2: 80 ppm |
| Com. Example 7 | PL-ZN | — | 15000 | 1000 | 61 | 2250 | Free acid | 40 | NO2: 140 ppm |
| | | | | | | | 0.8 pt | | |
| Com. Example 8 | PL-ZN | — | 15000 | 1200 | 580 | 3888 | 3.9 | 42 | NO2: 100 ppm |

| | Chemical | | | | | | | | |
|---|---|---|---|---|---|---|---|---|---|
| | convension | | | | | | | | |
| | treatment | Performances | | | | Coating performances | | | |
| Examples | solution | | Amounts | | | Electrode- | | | |
| and | properties | Treatment | of | Amounts | | position | | | |
| Comparative | Added | solution | generated | of coating | | coating | | Solvent coating | |
| Examples | components | stabilities | sludge | SPC | GA | SPC | GA | SPC | GA |
| Example 1 | — | | ◯ | | | | | ◯ | |
| Example 2 | Mg: 200 ppm | | | | | | | | |
| Example 3 | Ni: 100 ppm | | | | | ◯ | | ◯ | |
| Example 4 | — | | ◯ | | | | | | |
| Example 5 | Co: 200 ppm | | | | | | | | |
| Example 6 | — | | | | | | | | |
| Example 7 | Ni: 300 ppm | | | | | | | | |
| Example 8 | — | | | | | | | | |
| Example 9 | Surface active agent | | | | | ◯ | ◯ | ◯ | |
| Com. Example 1 | — | X | — | — | — | — | — | — | — |
| Com. Example 2 | Mg: 200 ppm | | X | X | ◯ | X | ◯ | X | ◯ |
| Com. Example 3 | Ni: 100 ppm | X | — | — | — | — | — | — | — |
| Com. Example 4 | — | | Δ | X | ◯ | X | Δ | X | ◯ |
| Com. Example 5 | Ni: 500 ppm | Δ | Δ | | | X | Δ | X | X |
| Com. Example 6 | Ni: 500 ppm | X | — | — | — | — | — | — | — |
| Com. Example 7 | Ni: 1000 ppm | ◯ | X | | | | ◯ | | ◯ |
| | Mn: 600 ppm | | | | | | | | |
| | Cu: 10 ppm | | | | | | | | |
| | Fe: 100 ppm | | | | | | | | |
| Com. Example 8 | Ni: 1000 ppm | ◯ | X | Δ | ◯ | ◯ | | ◯ | |
| | Mn: 500 pppm | | | | | | | | |

What is claimed is:

1. A chemical conversion treatment liquid for a metallic material, comprising an aqueous solution at pH 3.6 to 4.4 comprising:
500 to 4,000 ppm of phosphate ions and
300 to 1200 ppm of zinc ions,
wherein coefficient K of the liquid is in a range of 1 to 50, as calculated according the formula I:
K=10^{X}×P²×Z³/10¹⁸ (I)
where “P” is phosphate ion concentration in parts per million, “Z” is zinc ion concentration in parts per million, and “X” is pH.

2. The chemical conversion treatment liquid for a metallic material according to claim 1, which contains nitrate ions, fluoride ions and, as a coating chemical conversion accelerator, nitrite ions or hydroxylamine, wherein concentration of the fluoride ions is from 20 to 240 ppm.

3. The chemical conversion treatment liquid for a metallic material according to claim 1, comprising 750 to 3,500 ppm of phosphate ions, 400 to 1,100 ppm of zinc ions and having the coefficient K in the range of 2 to 40.

4. The chemical conversion treatment liquid for a metallic material according to claim 1, comprising 1,000 to 3,000 ppm of phosphate ions, 500 to 1,000 ppm of zinc ions and having the coefficient K in the range of 3 to 30.

5. The chemical conversion treatment liquid for a metallic material according to claim 1, wherein the pH of the treatment liquid is 3.8 to 4.2.

6. A process for chemical conversion treatment of a metallic material, which comprises:
contacting surfaces of the metallic material with a surface conditioning liquid at pH 7.0 to 11.0 containing 100 to 2,000 ppm of fine zinc phosphate particles and,
immediately thereafter, contacting with the chemical conversion treatment liquid of claim 1 held at 30 to 60° C. to form a zinc phosphate coating over the surface of the metallic material.

7. The process for chemical conversion treatment of a metallic material, of claim 6 wherein temperature of the treatment liquid is 35 to 45° C. and the chemical conversion treatment liquid comprises 750 to 3,500 ppm of phosphate ions, 400 to 1,100 ppm of zinc ions and having the coefficient K in the range of 2 to 40.

8. The process for chemical conversion treatment of a metallic material, of claim 6 wherein the chemical conversion treatment liquid contains nitrate ions, fluoride ions and, as a coating chemical conversion accelerator, nitrite ions or hydroxylamine, wherein concentration of the fluoride ions is from 20 to 240 ppm.

9. The process for chemical conversion treatment of a metallic material, of claim 6 wherein the chemical conversion treatment liquid comprises 1,000 to 3,000 ppm of phosphate ions, 500 to 1,000 ppm of zinc ions and having the coefficient K in the range of 3 to 30.

10. The process for chemical conversion treatment of a metallic material, of claim 6 wherein the chemical conversion treatment liquid has a pH of 3.8 to 4.2.
